(19) United States
(12) Patent Application Publication
(10) Pub. No.: US 2009/0042504 A1
(43) Pub. Date: Feb. 12, 2009

(54) Tunnel cover for a tunnel for controlled ventilation of gas

(76) Inventors: Maria Kumm, Vasteras (SE); Anders Bergqvist, Stockholm (SE)

Correspondence Address: YOUNG & THOMPSON, 209 Madison Street, Suite 500, ALEXANDRIA, VA, 22314, US

(21) Appl. No.: 11/665,781

(22) PCT Filed: Oct. 19, 2005
(86) PCT No.: PCT/SE2005/001561

§ 371 Date: Apr. 19, 2007

(30) Foreign Application Priority Data
Oct. 19, 2004 (SE) 0402565-6

(51) Int. Cl. E21F 1/00; A62C 3/00

(52) U.S. Cl. 454/167; 169/54

(57) ABSTRACT

A system, in accordance with the invention, relates to ventilating a tunnel 1 in the event of fire or emission of gases C or aerosols. The system comprises a tunnel cover 20 and a mobile fan 21. The tunnel cover 20 has an opening 29 through which the fan 21 blows air. This increases the static pressure at the cover 20, which change the direction of air at a desired direction. One of the advantages of the invention is that the tunnel cover 20 makes it possible to utilise considerably smaller mobile fans 21 to ventilate a tunnel 1 in the event of fire or emission of gases than when using earlier known techniques.

### TECHNICAL FIELD

The invention concerns devices, methods and systems for ventilation of tunnels in the event of fire, emission of dangerous or unhealthy chemicals and other similar events.

### BACKGROUND ART

Experience from major fire accidents in tunnels show that rescue operations at sites of fire or other events/accidents in tunnels raise problems for emergency services. Examples of alternative terms used for emergency services are: fire department, fire protection service, fire brigade or civil defence. In the text that follows, “fires and smoke” is used to describe the technical standpoint. Equivalents could be described by using dangerous or unhealthy gases or aerosols, which, for some reason have been emitted in a tunnel. One of the problems arises from the fact that the great majority of tunnels usually are underground, limiting the number of exits/entrances. Another problem is that, usually, smoke cannot be ventilated away vertically from a fire in a tunnel; the tunnel becomes filled with smoke. Most modern road tunnels currently in use are ventilated by means of a fixed installation of a longitudinal ventilation system in the tunnel chamber, which can be used in the event of fire, whilst most types of railway tunnels and technical supply tunnels lack any possibility of removing smoke from a fire by means of ventilation. This means that, in many cases, the emergency services have great difficulty in carrying out fire and rescue operations. The emergency services do not have an overview of the site of the accident. People may need to be evacuated, and the emergency services perform rescue operations without clear knowledge of the state inside a tunnel filled with smoke.

All over the world, when planning safety measures concerning tunnels, the various solutions available are carefully considered and extensive risk analyses are usually made. Among other aspects calculations for accidents of different magnitudes and the consequences thereof are included. In addition it is normal to carry out analyses of how people affected are likely to behave in such accidents. Conclusions that can be drawn from these studies and analyses are used when designing and dimensioning the safety provisions for each tunnel in question.

What, on the other hand, is missing in most of these studies and analyses is a detailed description of the active measures that are to be taken to reduce the consequences if/when accidents occur. Local emergency services are usually expected to carry out such measures. This aspect of safety concepts seems, by and large, to be very poorly analysed and very few pertinent analyses are officially available, in disparity with most other aspects of the safety concept for tunnel environments. Experience shows that those responsible for designing modern tunnels assume, in many cases, that local authorities, for example the local fire brigade, can handle accidents that may occur, quickly, safely and effectively. Experience also shows that, in general, local emergency services do not react, nor act to inform those responsible for safety measures that plans are made for eventualities for which the services are not appropriately dimensioned, current operational procedures cannot handle and that they have neither the personnel nor the equipment required to comply with the plans.

For the emergency services, the most important measures towards reducing the consequences of fires in tunnels is short distances and simple ways for those involved in evacuation to move to safe environments, that rescue workers can get close to the fire in a safe, smoke-free environment and that the fire is not allowed to develop rapidly in intensity before fire-fighting activities can be started.

The following criteria are usually used when dimensioning emergency operations for a fire in a tunnel:
how many people rescue workers have to help to get out to a safe environment
the size of the fire and, thus, how high the temperature and heat radiation that affects rescue workers will be
the distance(s) that rescue workers will have to cover in a smoke-filled environment.

Modern road tunnels are usually designed as double tubular constructions in which traffic flows in one direction in one tunnel and in the opposite direction in the other. Fixed fans are installed in such tunnels. When a fire breaks out smoke can be ventilated away through the tunnel by means of the fans downstream of the fire and fire-fighting can start in a smoke-free environment.

When fire breaks out in road tunnels with two-way traffic in a single tunnel, e.g. the Muskötunnel, south of Stockholm, Sweden, in railway tunnels and technical service supply tunnels, there are usually no fixed fans installed. As a consequence there is no possibility to control the spread of smoke and large parts of such tunnels fill with smoke during a fire. This seriously weakens the possibilities of carrying out effective rescue operations and saving lives. Without feasibility for fire ventilation the spread of smoke from a fire in a single tubular tunnel can entail advanced smoke-helmeted operations before fire-fighting can commence.

Fateful accidents like those in the Mont Blanc and Tauern tunnels in 1999 show that emergency services methods are adjusted to suit smaller scale fires and it being easy for fire-fighters to gain easy access to a fire.

Local emergency services, such as those in Sweden, use, in principle, the following blanket tactical directives when dealing with fires in tunnels:
acting in a tunnel to extinguish the fire and/or get rid of smoke, thus eliminating the threat towards people affected in the tunnel,
acting in a tunnel to assist people/save life and facilitate evacuation of people affected in the tunnel,
working actively to take care of people evacuated to a safe environment inside or outside the tunnel.

When a rescue operation takes place, these different directives have to be combined to form an appropriate pattern for the specific accident.

The operational methods conceivable for use by emergency services in accordance with the tactical directives, stated above, are:
Actions in a tunnel to become orientated, i.e. observe and acquire an overview of the accident site. These actions are taken to acquire the basis for decision-taking for further operations. Such actions may need to take place in a smoke-filled area, which means that the personnel involved need protective clothing and equipment. Such actions need to be carried out immediately, be rapid and effective, as they must not cause delay to other parts of the operation.
Actions in a tunnel to extinguish a fire and to eliminate the threat towards people in the tunnel. Such actions may also need to be carried out in a dangerous environment with smoke and high levels of heat radiation, which means that the personnel taking part may need protective clothing and equipment. Fire fighting will probably cause a major problem and can probably be carried out in a number of different ways, of which the following are possible and conceivable methods:
Fire fighting using conventional nozzles.
Fire fighting using portable water monitors.
Fire fighting using water monitors mounted on vehicles.
Fire fighting using fans and water injection into air streams.
Fire fighting by removing burning objects from the tunnel.
Fire fighting using remote-controlled fire fighting equipment
Actions inside the tunnel to guide people, i.e. that those affected can move out from the tunnel. These actions may also need to take place in a dangerous environment with smoke and high-level heat radiation, which means that the personnel may need to have protective clothing and equipment.
Actions in a tunnel to carry people out from the tunnel, normally known as life saving. These actions, too, may need to take place in a dangerous environment with smoke and high-level heat radiation, which means that the personnel may need to have protective clothing and equipment.
Actions in a tunnel to rescue or assist people and facilitate survival in the tunnel. These actions may also need to take place in a dangerous environment with smoke and high-level heat radiation, which means that the personnel may need to have protective clothing and equipment.
Ventilation of a tunnel to control the flow and direction of smoke in the tunnel. The purpose for this may be to:
   ventilate to ensure existing flow in the tunnel, thereby facilitating evacuation and rescue work;
   ventilate to start flow in the tunnel in order to make evacuation possible and create a route of attack for rescue workers;
   ventilate to reverse the flow of smoke in a tunnel and facilitate lifesaving of people in the tunnel, downstream of the site of the fire.
Advanced emergency care in a safe environment at the site of an accident. This method will probably requires large resources if the number of people injured is high.

Rescue operations in tunnels require a major part of the taskforce working in a smoke-filled environment, if the ventilation available cannot ensure a smoke-free environment for the work involved. The first five of the aforementioned methods (1-5) are based on firemen equipped with breathing equipment and heat-resistant clothing working their way into the tunnel to carry out the work required. This method is called smoke-diving or BA-operations (Breathing Apparatus). It is a highly limiting factor towards efficient results. The range of a smoke-diving operation is limited partly by regulations for industrial welfare, which govern the form of an operation, and partly by the possibility of getting close to the site of the fire because of the environment in the tunnel and access to breathable air. Experience and different kinds of tests have shown that the maximum range of a smoke-diving operation in a smoke-filled but not particularly hot environment is between 100-150 metres. Many of the tunnels in Sweden are considerably longer than this.

During recent years emergency services, including those in Sweden, have improved their ability to carry out rescue operations by using overpressure fans to ventilate away fire fumes or smoke during an operation. This technique has also been used in tunnels. When it comes to fires in tunnels the method has not succeeded in achieving an effective airflow and thereby not the effect intended.

As mentioned earlier, known technology, using fixed fans, can make ventilation in tunnels possible during fires, as opposed to cases in which the emergency services transport to, and supply a tunnel with a fan intended to create sufficient airflow as required. In these cases the emergency services should have a mobile fan with enough capacity to create sufficient airflow in the tunnel. Achieving such an airflow using a freestanding fan at the entrance of a tunnel without tunnel cover requires the fan to have a very high capacity. Common mobile fans used by fire-fighting teams for ventilation at building fires have a capacity in the region of 8-9 m³/s. Since the emergency services have no other mobile fans these fans have also been put to use when fires have occurred in tunnels. The result has been far from good as it has not been possible to create a sufficiently strong airflow in tunnels. This entails a hazardous working environment for rescue workers and an inferior result of the emergency operation.

EP1395736 “Suction device for tunnel” describes a suction device for tunnels. The Patent describes, among other items, a device with the purpose of facilitating evacuation of people in the event of fire. Another purpose is to minimise fire damage to objects. Whirl-air covers are utilised to produce a more effective suction device in comparison with earlier techniques. Whirl-air covers are in place when a fire breaks out. The suction device presupposes that there is a separate ventilation duct in the direction of the length of the tunnel.

EP1112759 “Process for the ventilation of road tunnel”. The Patent describes, among other items, blinds that can be opened or closed during a fire in order to improve the extraction of smoke/fumes.

EP1081331 “Method and suction system for ventilation, i.e. smoke suction in tunnels”. One purpose of the method is to improve ability to extract smoke into an extraction duct for smoke.

One problem that remains in respect of ventilation of a tunnel during a fire, or other similar occurrence, is to create a sufficiently large longitudinal airflow along the length of a relatively long tunnel with no fixed fans. The airflow must be of such a magnitude as to be able to transport smoke or gases in the direction desired.

### SUMMARY OF THE INVENTION

One aim of the invention is to solve the aforementioned problems in the event of fire or emission in a tunnel. One object is to provide a device to cover the mouth of a tunnel, which, in an effective manner, facilitates ventilation of the tunnel as well as a device which makes this possible in a cost-effective way.

This object is achieved by a device in accordance with patent claim 1. The device comprises an essentially airtight membrane, intended to cover most of the mouth of a tunnel, in the event of fire.

A further object of the invention is to produce a system, which ventilates a tunnel effectively in the event of fire. The system comprises the essentially airtight membrane which is intended to cover the greater part of the mouth of a tunnel, in addition the system includes a mobile fan and an opening in the membrane, the size of the opening mainly matches the diameter of a mobile fan or the front area of a set of fans, such as standing on a rack. The purpose of the mobile fan or sets of fans is to generate an airflow via the opening.

One advantage of the invention at hand is that it makes effective ventilation of a tunnel possible in the event of fire without the need of having fixed and powerfully dimensioned fans permanently installed in the tunnel.

One of the most important advantages of the invention is that the capacity of the fan that is required in order to ventilate a tunnel can be lowered considerably by using the cover at the mouth of the tunnel. Instead of needing to procure special fans in order to be able to ventilate the types of environment described, in the event of fire, it will now be possible to use the fans that are available at local emergency services. Numerous emergency service vehicles are already equipped with mobile fans, used to ventilate buildings such as private homes, commercial premises and apartment buildings. One significance of the invention is that emergency services will have the possibility of utilising ventilation as a working method during outbreaks of fire or emissions in tunnels, a method, which has not at all been the case using previous known techniques. It also leads to increased cost effectiveness since newer and larger fans need not be procured, an increased total efficiency as existing equipment can be used in more environments, and that the costs to society will be lower since the local emergency services will increase their capacity to extinguish fires in tunnels.

A further advantage of the invention in question is that it enables rescue operations to be considerably safer than when using previous known techniques, as the invention makes it possible to ventilate smoke, fire fumes away or combustion as, prior to commencement of rescue work, to a greater extent than when using earlier known techniques.

A membrane is foldable, and in one embodiment inflatable, which enable either storage of the membrane at the mouth of the tunnel. The membrane may also be intended to be transported in a compact and space saving manner, for instance on a rescue vehicle.

Yet another object of the invention is to provide a method to generate a sufficient flow through a tunnel in order to ventilate the tunnel of smoke, combustion gas and other gases/aerosols. The method comprises the step of establishing a flow of air by means of at least one mobile fan through the opening in the membrane.

### BRIEF DESCRIPTION OF THE DRAWINGS

The present invention will be described in more detail in connection with the enclosed schematic drawings.

FIG. 1 shows a general outline of the invention, the membrane covering the mouth of the tunnel, but prior to activating the fan.

FIG. 2 shows an outline of the invention, the membrane 20 covering the mouth of the tunnel and the fan activated.

FIG. 3 is an example of a membrane 20 mounted in a tunnel. FIG. 3 shows a view of the membrane 20 as seen from a position outside the tunnel. The membrane 20 is essentially airtight.

FIG. 4 shows a simplified flow chart of a method according to the invention.

FIG. 5 is an example of a membrane 20 which is inflatable. The membrane 20 in FIG. 5 comprises air-canals 42, which stabilizes the membrane 20 when it is inflatable.

### DETAILED DESCRIPTION OF THE INVENTION

As mentioned earlier, experience and various forms of tests show that the maximum range of smoke-diving operations in smoke-filled but not particularly hot environments lies between 100-150 metres. Many tunnels are considerably longer than 100-150 metres. The inventors have come to the conclusion that it is an essential advantage to carry out ventilation to increase accessibility when fires occur in longer tunnels. In such cases of fire, ventilation is an effective method towards enabling rescue operations to be carried out.

Ventilation of smoke and/or combustion gases, in accordance with the invention, facilitates both rescue operations and evacuation of people affected by fire or emission of dangerous substances in a tunnel. During a situation involving fire, the function of the fan is to create an airflow in the tunnel of sufficient velocity that it takes away the smoke or other gases/aerosols from a designated area in the tunnel. This is in order to create the possibility of facilitating evacuation or for rescue workers to reach the fire or help people get out from the tunnel. The leader of an operation may be faced with an early decision to attempt to control the flow of combustion gases by means of built-in or mobile systems. In order to achieve the desired effect, the fans and system used have to have sufficient capacity.

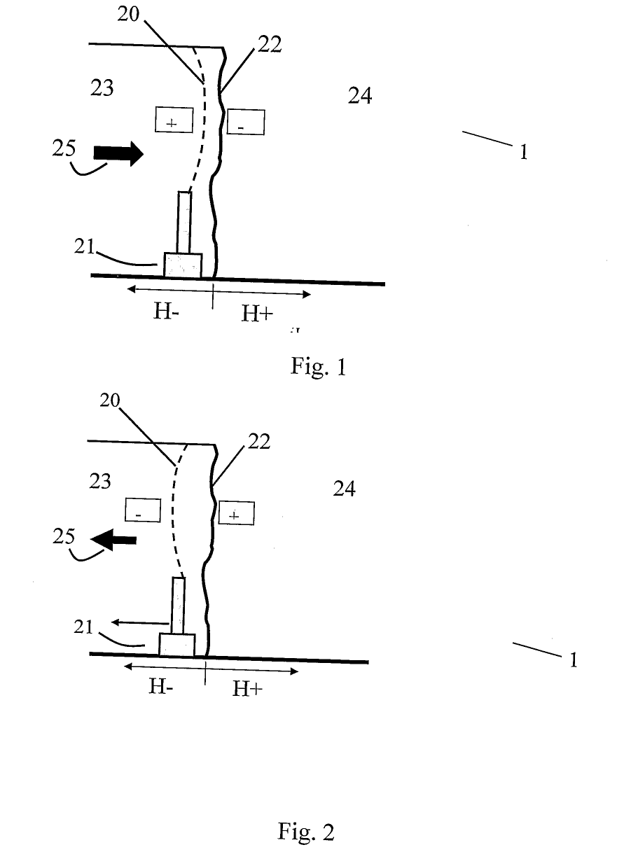

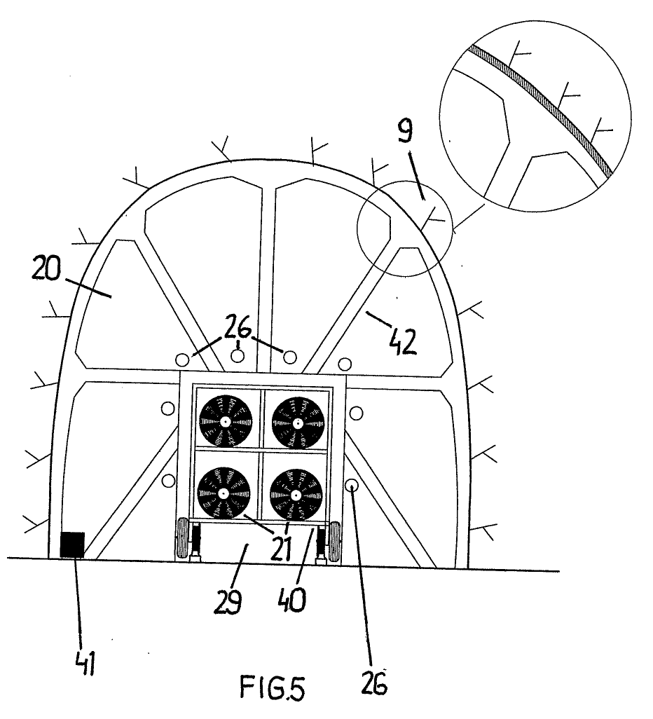

A device in accordance with the invention is made up of an essentially airtight membrane, the purpose being to cover the greater part of the mouth of a tunnel 22. Such a membrane 20 is schematically shown from the side in FIGS. 1 and 2. An example of such a membrane is also shown in FIG. 5. One example of the design of the membrane 20 is a tarpaulin type of unit or an inflatable unit. The membrane 20 has an opening to allow the airflow from the at least one mobile fan 21 to pass through. The opening in the membrane has, to all intents and purposes, the same diameter as that of the mobile fan, which is to be placed on one side of the membrane. A typical membrane 20 is mobile. In addition the device may include suspension devices 9 to fasten the membrane 20 to the tunnel walls. Examples of suspension devices 9 are hooks and eyes or elastic fixing devices. An alternative term for suspension devices is resilient mounting.

In FIGS. 1 and 2 “In” is indicated by 23 and “Out” by 24.

A system in accordance with the invention refers to ventilation of a tunnel in the event of fire or emission in a tunnel, which does not have ventilation ducts. A typical tunnel is an underground tunnel with a height of at least 2 metres. The system consists of the aforementioned essentially airtight membrane 20 the purpose of which is to cover the greater part of the mouth of a tunnel 22 in the event of fire, together with at least one mobile fan 21, which is to be placed on one side of the membrane. The system includes an opening 29 in the membrane 20 the size of which is, to all intents and purposes, the same as the front area of the at least one mobile fan 21. The purpose of the mobile fan 21 is to generate an airflow through the opening 29, whereby a sufficiently large flow is generated through the tunnel 1 to ventilate smoke and combustion gases out from the tunnel 1.

As mentioned earlier, the mobile fans, used for ventilation in buildings in which fire has broken out using earlier known technology, have capacities in the order of 8-9 m³/s. One of the advantages of the invention in question is that it also enables existing equipment to be used for ventilation of combustion gases or other gases in a tunnel. Thus, in an operational form of the system at least one mobile fan 21 is included.

In operational form the membrane 20 has a number of openable areas, hereafter called holes, the purpose being to allow additional airflow to be let in when stable airflow has been achieved in the tunnel 1. These holes 26 are kept closed until a stable airflow has been reached. These applications for additional air create a greater flow inside the tunnel 1 by means of an ejector effect.

The critical velocity of airflow required to prevent combustion gases or other gases spreading in an undesirable direction can be seen as relatively well investigated, being supported both by model trials at the Health and Safety Laboratory in Buxton, England, as by full-scale trials in the Memorial Tunnel, West Virginia, USA. During these full-scale trials it was shown that the airflow speed required to prevent backlayering in a 100 MW fire is approximately 3 m/s (600 fpm)(Parsons Brinckenhoff, 1996). For smaller fires the critical airflow speed is somewhat lower because of a lower decrease of air pressure over the site of the fire.

It may sometimes also be desirable to completely reverse the natural direction of movement in a tunnel, for example to be able to search for people, caught in the combustion gases from the fire, who are no longer capable of evacuating themselves. One prerequisite for being able to influence the direction of airflow is that the emergency services have access to the decision data required to make the right decision analytically as well as having reliable fans to bring about the desired effect.

The following data has been produced using CDF (Computer Fluid Dynamics) calculations of the flow in the 523 m long and 23.4 m² volume Manesse tunnel and the 2118 m 45.4 m² Käferberg tunnel in Switzerland. The fan capacity calculated was 37.5 m³/s with a fan diameter of 1.22 metres. This should be compared with the mobile fans commonly used by emergency services for ventilation during building fires, which have a capacity of 8-9 m³/s.

Mannese tunnel:

Establishing flow in the tunnel using a mobile fan; no fire.

Final airflow speed after reversal: 3.7 m/s

Time required to reverse airflow: 4 minutes

Käferberg tunnel:

Establishing flow in the tunnel using a mobile fan; no fire.

Final airflow speed after reversal: 2.2 m/s

Time required to reverse airflow: 10 minutes

Mannese tunnel:

Establishing airflow in the tunnel using a mobile fan and with a train in the tunnel; no fire.

Final airflow speed after reversal: 3.6 m/s

Time required to reverse airflow: 1 minute

Käferberg tunnel

Establishing airflow in tunnel using a mobile fan and with a train in the tunnel; no fire.

Final airflow speed after reversal: 2.2 m/s

Time required to reverse airflow: 3 minutes

Mannese tunnel

Establishing airflow in tunnel using a mobile fan, with a train in the tunnel; 15 MW fire

Final airflow speed after reversal: 2.5 m/s

Time required to reverse airflow: 1 minute

Käferberg tunnel

Establishing airflow in tunnel using a mobile fan, with a train in the tunnel; 15 MW fire

Final airflow speed after reversal: 2.1 m/s

Time required to reverse airflow: 3 minutes

In the event of fire, or other similar situations, the capacity of a fan, or a number of fans, must be dimensioned for the total drop in air pressure in the tunnel with openings. This drop in air pressure, simplified, consists of the following parameters:

Drop in air pressure caused by friction against tunnel walls
Surge losses caused by possible increase or decrease of area
Drop in air pressure over fire (not applicable if no fire)
Drop in air pressure over a possible vehicle, standing still
Effect of wind at mouth(s) of tunnel

Frictional drop in pressure is caused by factors such as airflow speed, air temperature, average cross-sectional area of the tunnel and roughness of the surface of the tunnel walls. This type of drop in pressure is predominant for ventilation of gases in a tunnel. Other causes of resistance counteracting the purpose of a fan can, for example, be counteracting wind or thermal driving forces such as those caused by differences in height between tunnel portals. The length of a tunnel and its cross section, together with external wind effects, are the parameters that have most effect on the possibility of reversing airflow in the tunnel 1.

All ventilation is based on air being moved from an area with higher pressure to one with lower pressure. The total pressure of a fan consists partly of static pressure and partly of dynamic velocity pressure. When using overpressure fans in buildings, the pressure caused by movement in the fan creates a small overpressure inside the building. Air is forced into the building by means of a mobile fan and the reduction of area effectively caused by the outflow opening relative to the volume inside the building “resists”, causing overpressure. In a tunnel, the area is relatively constant and the outflow opening for air is, in principle, equal to the area of the cross section of the tunnel. By themselves, free-blowing fans create negligible static pressure; only the dynamic pressure can ventilate possible combustion gases out from the tunnel 1. This means that the effect of this type of fan, placed only at the mouth of the tunnel 1 for the purpose of reversing the airflow in the event of fire, is limited, primarily by the cross sectional area of the tunnel and frictional drop in pressure. The drop in pressure arising over the fire also shortens the maximum tunnel length for which such an arrangement can function.

Adverse winds may partly be made up from pressure above the mouth of the tunnel 1 from the direction the wind is blowing and partly from an under pressure at the leeward end. As wind is a strong driving force when compared with a mobile fan 21, problems can arise if the wind counteracts the desired direction of airflow, see FIG. 1, in which wind direction is indicated by the arrow 25.

As total pressure consists of the sum of static and dynamic pressures, the membrane 20, which builds up static pressure in a tunnel, can assist in overcoming resistance in the tunnel caused by a conceivable adverse wind. FIG. 1 shows that the wind 25 is slowed down/stopped by the membrane 20 mounted in accordance with the invention. The membrane 20 stops the airflow in the tunnel 1, caused by the wind 25, see FIG. 1. Since this airflow has stopped, the static pressure will be high at the inside of the membrane 20. This high pressure is indicated by + in FIG. 1. When the mobile fan, 21 in FIGS. 1 and 2 is started, all the air that initially passes through the fan 21 will increase the static pressure at the membrane 20. This will continue to be the case until this pressure can bring about the airflow, 25 in FIG. 2, by overcoming the drop in pressure, described above. When this airflow starts in the tunnel 1, the static pressure, in FIG. 2, will fall below the surrounding pressure outside the tunnel 24. Now, the airflow, 25 in picture 2, will begin to move in the direction desired and the smoke will then be steered in the direction intended. If a sufficiently large fan is used, the tunnel cover is superfluous as the drop in pressure, described above, can be overcome by the fan. But, as previously mentioned, such large fans are expensive, and the emergency services often already have smaller fans suitable for transporting on emergency vehicles already available.

The area of the fan or the resulting cone of air from the cone equals to:

$$A = \frac{π * {D}^{2}}{4}$$

The mass flow rate for each location along the axis of the air cone, or through the fan, can be described as:

$$m = A * ρ * u = \frac{π * {D}^{2}}{4} * ρ * u$$

ρ is the density. The momentum (mass flow times velocity) for each location along the axis of the air cone, or through the fan, can consequently be described as:

$$M = m * u = A * ρ * {u}^{2} = \frac{π * {D}^{2}}{4} * ρ * {u}^{2}$$

The primary airflows through the fans 21 and the resulting air velocity at the tunnel entrance cross-section can be defined as:

M_{fan}=M_{entrance} [symbol] m_{fan}*u_{fan}=m_{entrance}*u_{entrance}

An embodiment, in accordance with the invention, of the cover for tunnel openings 22 can, in principle, be used to make all freestanding fans 21 more effective. That is all types of ventilation using mobile and/or fixed fans which are not connected to an adjoining system, e.g. ventilation ducts. For other types of evacuation of combustion gases or other gases from minor incidents, e.g. smoke developed from overheating brakes, and for residual value salvage, the cover improves the effect of ventilation. In such cases no regard needs to be taken to the drop in pressure caused by fire.

A device and a system in accordance with the invention is not dependent on there being longitudinal ventilation ducts along the length of a tunnel.

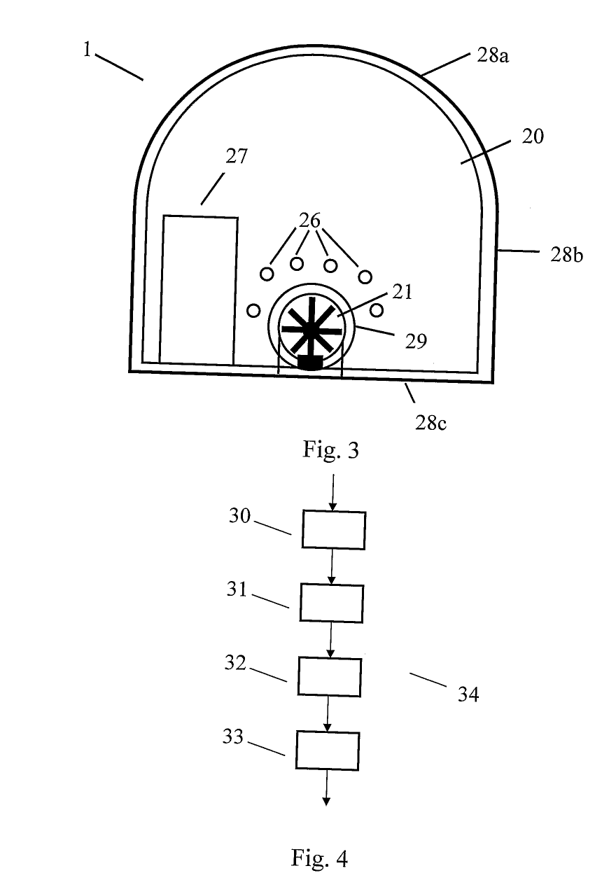

FIG. 3 is an example of a membrane 20 mounted in a tunnel. FIG. 3 shows a view of the membrane 20 as seen from a position outside the tunnel 1. The membrane 20 is essentially airtight. The fan 21 is positioned in front of the membrane 20. In FIG. 3 only one fan 21 is shown, however a system according the invention comprise any number of fans. FIG. 3 indicates that there may be a minor space between the edge of the membrane 20 and the roof 28a, the side 28b or the floor 28c of the tunnel. The membrane 20 comprises an opening 29 which diameter mainly matches the diameter of the fan 21. Equivalent is that the area of the opening 29 matches the area of the front of at least one fan 21. In an alternative embodiment there may be several openings 29. The opening or openings may comprise cross laid rods or a net. In the case when a number of fans are used the opening basically matches the size of the resulting front area of the fans.

The membrane 20 shown in FIG. 3 may comprise holes 26 with cover means. Such holes 26 are used to introduce an ejector effect after a stable air flow 25 in the desired direction has been established in the tunnel. It is advantage if the air flow of the fan 21 is directed in an upwards direction.

An example of an opening 27 similar to a door is shown in FIG. 3. The door or opening 27 is intended to be covered during the initial phase of use of fan 21. In one embodiment such an opening has a zipper. The opening 27 is intended to allow rescue personal and others to enter the tunnel after an air flow 25 in the desired direction has been established. Evacuation through the opening 27 is another purpose. There are several possible embodiments of the opening 27. It may be semi-round, or a triangle shaped part of the membrane.

FIG. 5 is an example of a membrane 20 which is inflatable. Such a membrane comprises an air-inlet 41. The membrane 20 in FIG. 5 comprises air-canals 42, which stabilizes the membrane 20 when it is inflated. Holes 26 to introduce an ejector effect may be positioned in non-inflatable sections of the membrane 20. Typically, the holes 26 have a removable cover attached. The holes may have any shapes and be of any number.

FIG. 5 further shows an example where four fans 21 are positioned in a movable rack 40, with two fans at the bottom and two on top. Such a rack 40 may be attached behind a truck during for transportation purposes.

The outer layer of the membrane 20 is essentially airtight. A small amount of air may pass through the surface of the membrane 20.

FIG. 4 is a simplified flow chart of a method 34 according to the invention. The method comprises a number of steps, such as:
Mounting 30 an essentially airtight membrane 20 in the tunnel such the membrane covers at most of one of the tunnel's openings 22. The mounting may involve blowing air into an inflatable membrane 20. It may involve rigging the membrane 20 in the roof 28a and walls 28b by means of suspension elements such as hooks.
Positioning 31 at least one mobile fan 21 at an opening 29 in the membrane 21. There may be several fans on a rolling rack 40 that are placed at the opening.
Establishing 32 a flow of air by means of the at least one mobile fan 21 through the opening 29. The mobile fan 21 or fans may be tilted upwards in order to accelerate air primarily in the upper part of the tunnel 1 where most of the fire gases are located.

The examples, given above, of operational forms must not limit the extent of the invention. The invention can be varied in many ways within the framework of the patent claims.

1. A device for facilitating a sufficiently large flow (25) to be generated through a tunnel in order to ventilate smoke, combustion gases, unhealthy gases or aerosols from the tunnel, the device comprises an essentially airtight membrane (20), which is intended to cover the most of a mouth of the tunnel (22) at a fire, the device comprises an opening (29) in the membrane (20) where the size of the opening (29), to all intents and purposes, is the same size as that of a front area of at least one mobile fan (21), which is intended to be positioned at one side of the membrane (20) and the at least one mobile fan (21) is intended to generate a flow of air through the opening (29).

2. A device according to claim 1 where the airtight membrane (20) is mobile.

3. A device according to claim 2 where the device comprises suspension elements.

4. A system for ventilation of a tunnel in the event of fire, the system generating a sufficiently large flow (25) through the tunnel to ventilate the tunnel from smoke, combustion gases, unhealthy gases or aerosols which system comprises:
an essentially airtight membrane (20) intended to cover the greater part of one of the mouth of a tunnel (22);
at least one mobile fan (21), intended to be positioned on one side of the membrane (20);
an opening (29) in the membrane (20) where the size of the opening (29), to all intents and purposes, is the same as the front area of the at least one mobile fan (21) intended to generate a flow through the opening (29).

5. A system according to claim 4 where the airtight membrane (20) is mobile.

6. A system according to claim 5 where the airtight membrane (20) is inflatable.

7. A system according to claim 6 where the device comprises suspension elements.

8. A system according to claim 7 where the at least one fan (21) has a maximum capacity of 30 m³/s.

9. A method to generate a sufficiently large flow (25) through a tunnel in order to ventilate the tunnel of smoke, combustion gas, unhealthy gases or aerosols characterized by
mounting (30) an essentially airtight membrane (20) in the tunnel such the membrane covers the greater part of one mouth of the tunnel (22);
positioning (31) at least one mobile fan (21) at an opening (29) in the membrane (21);
establishing (32) an airflow by means of the at least one mobile fan (21) through the opening (29) where the size of the opening (29), to all intents and purposes, is the same as the front area of the at least one mobile fan (21).

10. A method according to claim 9 characterized by the additional step of removing (33) a cover from holes (26) in the membrane (20), wherein an ejector effect is achieved.
